(19) United States
(12) Patent Application Publication
(10) Pub. No.: US 2022/0140874 A1
(43) Pub. Date: May 5, 2022

(54) METHOD AND SYSTEM FOR BEAMFORM MANAGEMENT FOR COMMUNICATIONS

(71) Applicant: GM GLOBAL TECHNOLOGY OPERATIONS LLC, Detroit, MI (US)

(72) Inventors: Venkata Naga Siva Vikas Vemuri, Novi, MI (US); Ashhad Mohammed, Farmington Hills, MI (US); Andrew J. MacDonald, Grosse Pointe Park, MI (US); Scott T. Droste, West Bloomfield, MI (US); Charles A. Everhart, Canton, MI (US)

(73) Assignee: GM GLOBAL TECHNOLOGY OPERATIONS LLC, Detroit, MI (US)

(21) Appl. No.: 17/084,127

(22) Filed: Oct. 29, 2020

(51) Int. Cl. H04B 7/06; H04L 5/00; H04B 7/0413

(52) U.S. Cl. CPC H04B 7/0617; H04B 7/0413; H04L 5/0048; H04B 7/0626

(57) ABSTRACT

A millimeter wave communication system for enhanced downlink beamforming and pairing is described. This includes a beamforming system for pairing with a mobile UE, using a base station with a MIMO antenna and a controller. The controller transmits first downlink beams from the MIMO antenna, including channel state information (CSI) reference signals. The mobile UE identifies a provisional downlink beam having a highest intensity CSI reference signal at the mobile UE. The controller receives a CSI reference signal resource indicator (CRI) feedback from the mobile UE that is responsive to the downlink beams and includes the provisional downlink beam, a present geographic position and trajectory of the mobile UE. A refined downlink beam is determined based upon the provisional downlink beam, the present geographic position, and trajectory of the mobile UE. The MIMO antenna transmits the refined downlink beam to execute a pairing with the mobile UE.

### INTRODUCTION

The disclosure generally relates to beamform management in millimeter wave communication systems, and more specifically to downlink beamform management between a network tower and an electronic device such as a piece of user equipment (UE), including wherein the UE may be an element of a vehicle system.

Millimeter wave communications, such as 5G communications, may operate with transmissions in one millimeter to 10 millimeter wavelengths. A UE device operating in this range of wavelengths have a relatively increased difficulty locking onto a communications signal from a network tower. As a result, a vehicle traveling along a roadway may experience delays or interruptions in communications. As such, there is a need to provide for improved communication linking between a network tower and a UE device to effect millimeter wave communication.

### SUMMARY

A system is described for use in millimeter wave communications that enhances downlink beamforming and pairing by employing feedback from a user equipment (UE) device, including a mobile UE that is arranged on a vehicle. This includes a beamforming system for pairing with the mobile UE, wherein the beamforming system has a base station with a Multiple-Input Multiple-Output (MIMO) MIMO antenna that is operatively connected to a controller. The controller includes algorithmic code that is executable to transmit a first plurality of downlink beams from the MIMO antenna, wherein the first plurality of downlink beams includes a plurality of channel state information (CSI) reference signals. The controller instructs the mobile UE to identify a provisional downlink beam, wherein the provisional downlink beam is one the first plurality of downlink beams having a highest intensity CSI reference signal at the mobile UE. The controller receives, via the MIMO antenna, a CSI reference signal resource indicator (CRI) feedback from the mobile UE that is responsive to the first plurality of downlink beams, wherein the CRI feedback message includes the provisional downlink beam, a present geographic position of the mobile UE, and a trajectory for the mobile UE. The controller determines a refined downlink beam based upon the provisional downlink beam, the present geographic position of the mobile UE, and the trajectory for the mobile UE, and transmits, via the MIMO antenna, the refined downlink beam to execute a pairing between the mobile UE and the MIMO antenna, thus achieving beam acquisition for wireless communication therebetween.

An aspect of the disclosure includes the controller including executable code to select one of the first plurality of downlink beams that is expected to have a highest intensity CSI reference signal at the mobile UE based upon the present geographic position of the mobile UE and the trajectory for the mobile UE.

Another aspect of the disclosure includes the controller including executable code to select the provisional downlink beam when it is expected to have a highest intensity CSI reference signal at the mobile UE based upon the present geographic position of the mobile UE and the trajectory for the mobile UE.

Another aspect of the disclosure includes the controller including executable code to select one of the first plurality of downlink beams that is adjacent to the provisional downlink beam when it is expected to have a highest intensity CSI reference signal at the mobile UE based upon the present geographic position of the mobile UE and the trajectory for the mobile UE.

Another aspect of the disclosure includes the controller including executable code to update the refined downlink beam based upon the present geographic position of the mobile UE and the trajectory for the mobile UE.

Another aspect of the disclosure includes the MIMO antenna being a Multiple-Input Multiple-Output (MIMO) antenna array.

Another aspect of the disclosure includes the MIMO antenna being a 4×4 antenna array. Alternatively, the MIMO antenna may be configured as a 6×6 antenna array, an 8×8 antenna array, a 10×10 antenna array, etc.

Another aspect of the disclosure includes the downlink beams being static downlink beams.

Another aspect of the disclosure includes the controller including algorithmic code to communicate between the controller and the mobile UE.

Another aspect of the disclosure includes the controller having algorithmic code that is executable to transmit, via the MIMO antenna, the refined downlink beam to execute the pairing between the mobile UE and the MIMO antenna to effect millimeter wave communication between the controller and the mobile UE.

Another aspect of the disclosure includes the mobile UE being arranged on a vehicle, wherein the CRI feedback message includes the provisional downlink beam, a present geographic position of the vehicle, and a trajectory for the vehicle.

Another aspect of the disclosure includes the trajectory for the vehicle being a present velocity for the vehicle and a direction of travel for the vehicle.

Another aspect of the disclosure includes a beamforming system for wireless communication to a user equipment (UE) that is arranged on a vehicle. The system includes a Multiple-Input Multiple-Output (MIMO) beamforming antenna in communication with a controller. The controller includes algorithmic code that is executable to transmit a first plurality of downlink beams from the MIMO beamforming antenna, wherein the first plurality of downlink beams includes a plurality of CSI reference signals, and instruct the UE to identify a provisional downlink beam, wherein the provisional downlink beam is one the first plurality of downlink beams having a highest intensity CSI reference signal at the UE. The MIMO beamforming antenna receives a CSI reference signal Resource Indicator (CRI) feedback message from the UE responsive to the first plurality of downlink beams, wherein the CRI feedback message includes a provisional downlink beam, a present geographic position of the vehicle, and a trajectory for the vehicle. A refined downlink beam is determined based upon the provisional downlink beam, the present geographic position of the vehicle, and the trajectory for the vehicle, and a pairing is executed between the controller and the UE via the refined downlink beam of the MIMO beamforming antenna.

Another aspect of the disclosure includes the controller including algorithmic code that is executable to effect millimeter wave communication between the controller and the UE via the refined downlink beam of the MIMO beamforming antenna based on the pairing between the controller and the UE.

Another aspect of the disclosure includes the controller having executable code to select one of the first plurality of downlink beams that is expected to have a highest intensity CSI reference signal at the mobile UE based upon the present geographic position of the vehicle and the trajectory for the vehicle.

Another aspect of the disclosure includes the controller having executable code to select the provisional downlink beam when it is expected to have a highest intensity CSI reference signal at the mobile UE based upon the present geographic position of the vehicle and the trajectory for the vehicle.

Another aspect of the disclosure includes the controller having executable code to select one of the first plurality of downlink beams that is adjacent to the provisional downlink beam when it is expected to have a highest intensity CSI reference signal at the mobile UE based upon the present geographic position of the vehicle and the trajectory for the vehicle.

Another aspect of the disclosure includes a method for forming a downlink beam that is transmitted by a beamforming antenna that includes sending a first plurality of downlink beams, wherein the first plurality of downlink beams includes a plurality of CSI reference signals, and receiving, at the beamforming antenna, CRI feedback from a UE. The CRI feedback from the UE includes identification of one of the plurality of CSI reference signals as a highest intensity CSI reference signal at the mobile UE based upon the present geographic position of the mobile UE and the trajectory for the mobile UE. The CRI feedback includes a location and a trajectory for the UE. A refined downlink beam is determined based upon the highest intensity CSI reference signal and the location and trajectory for the UE, and the beamforming antenna generates the refined downlink beam to communicate with the UE.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 pictorially illustrates a system for millimeter wave communication including a base station having a Multiple-Input Multiple-Output (MIMO) antenna that is configured for wireless communication with a mobile user equipment (UE) that may be arranged on a vehicle, in accordance with the disclosure.

FIG. 2 schematically illustrates a controller for controlling operation of a MIMO antenna that is configured for wireless communication with a mobile UE, in accordance with the disclosure.

FIG. 3 pictorially illustrates a plurality of synchronization signal block (SSB) regions that are arranged on a ground surface portion, and a vehicle that includes a mobile UE, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments can be practiced without some of these details. Moreover, for the purpose of clarity, certain technical material that is understood in the related art has not been described in detail to avoid unnecessarily obscuring the disclosure.

FIG. 1 pictorially illustrates a base station 100 having a Multiple-Input Multiple-Output (MIMO) antenna 10 that is operatively connected to a controller 15, wherein the MIMO antenna 10 is arranged to wirelessly communicate with a mobile user equipment (UE) 90 using radio-frequency transmission waves that having a wavelength band that is in the range of one millimeter to 10 millimeter. The base station 100 operates as a network node. The base station 100 may be a network tower that is capable of millimeter wave communication, including being capable of beamform management as an element of a wireless communication system, including a 5G wireless communication system. The MIMO antenna 10 is configured as a 4×4 antenna array in one embodiment. Alternatively, the MIMO antenna 10 may be configured as a 6×6 antenna array, an 8×8 antenna array, a 10×10 antenna array, etc.

The mobile UE 90 may be a cell phone, a satellite phone, or another device capable of wireless communication. The mobile UE 90 may be disposed on a vehicle 95 in one embodiment. In one embodiment the mobile UE 90 includes a software application having a wireless protocol to communicate with an on-vehicle telematics system 94, and the mobile UE 90 executes the extra-vehicle communication, including communicating with the base station 100 using millimeter wave communication technology, i.e., 5G.

The vehicle 95 may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

The vehicle 95 includes, in one embodiment, a Global Position System (GPS) sensor 91, a navigation system 92, a Human-Machine Interface (HMI) system 93, the telematics system 94, and a plurality of on-vehicle sensors 96. In one embodiment, the GPS sensor 91 may be replaced by a Global Navigation Satellite System (GNSS) sensor.

The navigation system 92 is configured to determine a travel route and a destination for the vehicle 95 based upon user inputs to a Human-Machine Interface (HMI) system 93. The HMI system 93 provides for human/machine interaction, for purposes of directing operation of the navigation system 92, etc. The HMI system 93 monitors operator inputs and provides information to the operator. The HMI system 93 communicates with and/or controls operation of a plurality of in-vehicle operator interface device(s). The HMI system 93 may be configured as a plurality of controllers and associated sensing devices in an embodiment of the system described herein, and can include an electronic visual display module, e.g., a liquid crystal display (LCD) device, a heads-up display (HUD), an audio feedback device, etc. The navigation system 92 is arranged to determine a travel route and a destination for the vehicle 95 based upon user inputs to the HMI system 93.

The telematics system 94 includes a wireless telematics communication system that is capable of extra-vehicle communications, including communicating with a communication network system having wireless and wired communication capabilities. The extra-vehicle communication includes short-range vehicle-to-vehicle (V2V) communication and/or vehicle-to-everything (V2x) communication, which may include communication with an infrastructure monitor, e.g., a traffic camera, and communication to a proximal pedestrian, etc. In addition, the telematics system 94 has a wireless telematics communication system capable of short-range wireless communication to an on-vehicle cell phone, which may be the mobile UE 90. The telematics system 94 may be employed to determine a geographical position of the vehicle 95 by triangulation methods in conjunction with a plurality of proximal cellphone towers, including, e.g., the base station 100.

The plurality of on-vehicle sensors 96 include, by way of non-limiting examples, a yaw sensor, a steering angle sensor, wheel speed sensors, etc. that may be employed to determine parameters that include steering angle, vehicle heading, vehicle speed, vehicle acceleration, etc.

The GPS sensor 91, the navigation system 92, the plurality of on-vehicle sensors 96, and/or other on-vehicle systems are arranged to determine vehicle travel parameters, including a present geographic position 80 and a trajectory 85 for the vehicle 95. The present geographic position 80 of the vehicle 95 includes parameters that include a present geophysical position and vehicle altitude or elevation. The trajectory 85 includes parameters that include vehicle heading, vehicle speed, vehicle acceleration, and altitude or elevation change. The vehicle heading may be defined in relation to a true north heading in one embodiment. Alternatively, the vehicle heading may be defined as an azimuth in relation to the base station 100.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

This includes wireless communication that includes downlink beamform management between the base state 100 and mobile UE 90.

Millimeter waves, also known as extremely high frequency (EHF), refer to a band of radio frequencies employed in 5G networks. Compared to frequencies less than 5 GHz, millimeter wave technology facilitates signal transmission on frequencies between 30 GHz and 300 GHz. Millimeter waves propagate solely by line-of-sight paths and are not reflected by the ionosphere nor do they travel along the Earth. At some power densities they may blocked by building walls and suffer significant attenuation passing through foliage.

Beamforming is a traffic-signaling system for cellular base stations that identifies the most efficient data-delivery route to a particular user, and it reduces interference for nearby users in the process.

The support of millimeter wave frequencies requires directional links, and associated beam management. Beam management includes a set of physical and medium access control procedures to acquire and maintain a set of beam pair links between a base station and a UE, e.g., base station 100 being paired with mobile UE 90. Beam management is applied for downlink transmission, uplink transmission and reception. These procedures include beam sweeping, beam measurement, beam determination, beam reporting, and beam recovery.

Initial access procedures are employed to establish a connection between the base station 100 and the mobile UE 90. This includes, at the physical layer, using synchronization signal blocks (SSB) that are transmitted as a burst in the downlink direction, i.e., from the base station 100 to the mobile UE 90. Once connected, the same beam pair link can be used for subsequent transmissions. If necessary, the beams are further refined using CSI-RS (for downlink) and SRS (for uplink). In case of beam failure, these pair links can be reestablished.

The MIMO antenna 10 employs a static directional beam for wireless communication connection between the base station 100 and the mobile UE 90.

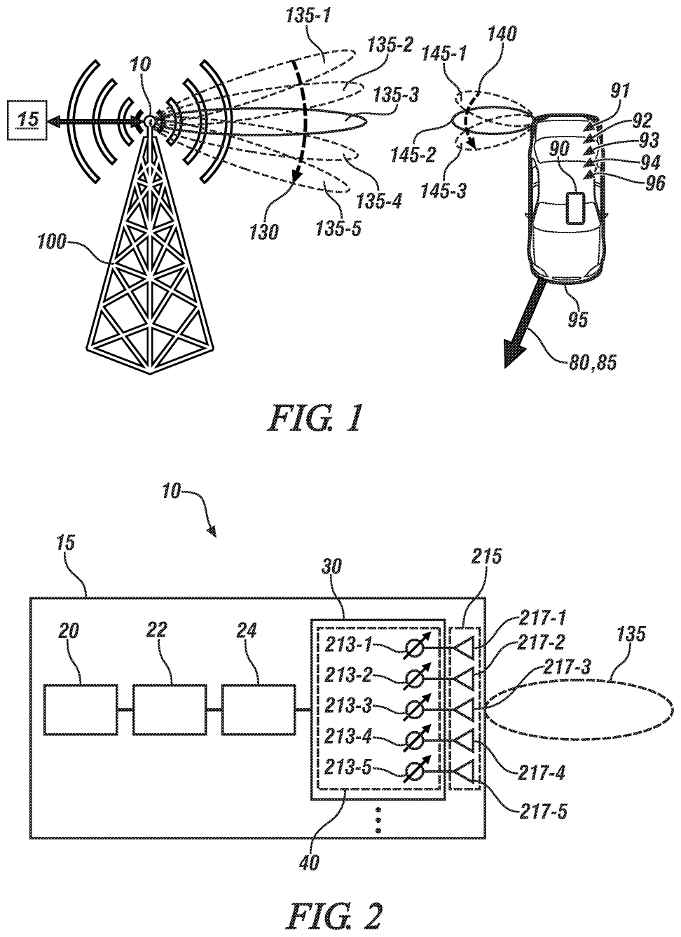

FIG. 2 schematically shows details related to an embodiment of the MIMO antenna 10, including the controller 15 for the MIMO antenna 10, that includes a processor 20, a communication processor 22, a radio-frequency integrated circuit (RFIC) 24, and an antenna module 30 that includes an antenna array 215.

Operations performed by the controller 15 as described hereinafter may be executed by at least one processor, e.g., processor 20, with such operations reduced to instructions in the form of algorithmic code that is stored in an electronic storage device and are executable by the processor 20.

The processor 20 may include a microprocessor or any suitable type of processing circuitry, such as one or more general-purpose processors, a Digital Signal Processor (DSP), a Programmable Logic Device (PLD), an Application-Specific Integrated Circuit (ASIC), a Field-Programmable Gate Array (FPGA), etc. In addition, when a general purpose computer accesses code for implementing the processing shown herein, the execution of the code transforms the general purpose computer into a special purpose computer for executing the processing shown herein. Certain of the functions and steps provided herein Figures may be implemented in hardware, software, or a combination thereof and may be performed in whole or in part within programmed instructions of the processor 20.

The communication processor 22 may include various processing circuitry for controlling first to fifth phase shifters 213-1 to 213-5 of the antenna module 30 to control the phases of signals transmitted and/or received through first to fifth antenna elements 217-1 to 217-5 to generate a transmission beam and/or a reception beam in a selected direction. A single beam 135 emanating (as shown) from the third antenna element 217-3 is depicted for the purpose of illustration.

The communication processor 22 may be employed to establish a communication channel corresponding to a designated frequency band to support 5G network communication between the base station 100 and the mobile UE 90.

The RFIC 24 may convert a baseband signal generated by the communication processor 22 into a radio-frequency (RF) signal associated with a 5G network.

The antenna module 30 may include the first, second, third, fourth and fifth phase shifters 213-1, 213-2, 213-3, 213-4, 213-5, i.e., the first to fifth phase shifters 213-1 to 213-5. The antenna module 30 also includes the antenna array 215 having, in one embodiment, first, second, third, fourth and fifth beamforming antenna elements 217-1, 217-2, 217-3, 217-4, and 217-5 which may be referred to hereinafter as first to fifth beamforming antenna elements 217-1 to 217-5. The first to fifth beamforming antenna elements 217-1 to 217-5 may be electrically connected to a respective one of the first to fifth phase shifters 213-1 to 213-5.

In a 5G system, beamforming technology may be used to overcome high signal attenuation in transmitting and receiving signals in the millimeter wave frequency band. The beamforming technology may also be used for signal transmission/reception in the mobile UE 90. The mobile UE 90 may create various beams through phase changes in the antenna array 215.

Referring again to FIG. 1, the base station 100 is configured to perform a beam detection to establish a pairing for wireless communication with the mobile UE 90. For beam detection, the base station 100 may perform a transmission beam sweeping 130 at least one time by sequentially transmitting a plurality of downlink static transmission beams, for example, first to fifth transmission beams 135-1, 135-2, 135-3, 135-4, 135-5, respectively (referred to hereinafter as transmission beams 135-1 to 135-5). The transmission beams 135-1 to 135-5 may be formed by the first to fifth beamforming antenna elements 217-1 to 217-5 that are described with reference to FIG. 2.

Referring again to FIG. 1, the transmission beams 135-1 to 135-5 are oriented in different directions. Each of the transmission beams 135-1 to 135-5 may include, for example, at least one synchronization sequence (SS) over one physical broadcast channel (PBCH) block, referred to herein as a SS/PBCH block. The SS/PBCH block may be used to periodically measure the strength of a channel or a beam of the mobile UE 90.

Each of the transmission beams 135-1 to 135-5 may include at least one channel state information-reference signal (CSI-RS). A CSI-RS may refer, for example, to a reference signal that may be flexibly configured by the base station 100, and may be transmitted periodically, semi-persistently or aperiodically. The mobile UE 90 may measure the intensities of a channel and a beam using the CSI-RS.

The transmission beams 135-1 to 135-5 may have a radiation pattern with a selected beam width. For example, each of the transmission beams 135-1 to 135-5 may have a sharp radiation pattern having a narrow beam width. Beam parameters include, for example, a specific angle (e.g., beam direction), a specific intensity (e.g., beam intensity), and a specific width (e.g., beam width).

The mobile UE 90 may perform a reception beam sweeping 140 while the base station 100 is performing the transmission beam sweeping 130. For example, while the base station 100 is performing first transmission beam sweeping 130, the mobile UE 90 may fix a first reception beam 145-1 in a first direction to receive a signal transmitted by at least one of the first to fifth transmission beams 135-1 to 135-5. While the base station 100 is performing second transmission beam sweeping 130, the mobile UE 90 may fix a second reception beam 145-2 in a second direction to receive a signal transmitted by the first to fifth transmission beams 135-1 to 135-5. While the base station 100 is performing third transmission beam sweeping 130, the mobile UE 90 may fix a third reception beam 145-3 in a third direction to receive a signal transmitted by the first to fifth transmission beams 135-1 to 135-5. As described above, the mobile UE 90 may select a communication-enabled reception beam (e.g., second reception beam 145-2) and a communication-enabled transmission beam (e.g., third transmission beam 135-3), based on a result of a signal receiving operation through reception beam sweeping 140.

Based on the communication-enabled transmission/reception beams being determined, the base station 100 and the mobile UE 90 may transmit and/or receive pieces of basic information for cell configuration and configure information for additional beam management, based on the pieces of basic information. For example, the beam management information may include detailed information of a configured beam, and configuration information of the CSI-RS, or an additional reference signal.

In addition, the mobile UE 90 may monitor beam strengths, i.e., the intensities of a channel and a beam using the CSI-RS included in a transmission beam.

The mobile UE 90 may adaptively select one of the transmission beams 135-1 to 135-5 as having good quality using the monitoring operation. If the mobile UE 90 is moved or beams are blocked whereby communication is disconnected, the beam sweeping operation may be re-performed to determine a communication-enabled beam.

The controller 15 includes algorithmic code that is executable to form and transmit a first plurality of downlink beams from the MIMO antenna, wherein the first plurality of downlink beams includes a plurality of channel state information (CSI) reference signals. The controller 15 receives, via the MIMO antenna, a CSI reference signal resource indicator (CRI) feedback from the vehicle 95 that is responsive to the first plurality of downlink beams. The CRI feedback may include, by way of non-limiting examples, a bandwidth, transmission mode, propagation channel, a beamforming mode, a precoding granularity, correlation and antenna configuration, cell-specific reference signal, eMIMO type, CSI-RS resource parameters, downlink power allocation, reporting mode, and PDSCH messages. The CRI feedback further includes identification of one of the plurality of CSI reference signals as a strongest CSI reference signal, a present geographic position of the vehicle 95, and a trajectory for the vehicle 95. A refined downlink beam is determined based upon the strongest CSI reference signal, the present geographic position of the vehicle 95 and the trajectory for the vehicle 95. The refined downlink beam is transmitted, via the MIMO antenna, to the vehicle 95 to execute a pairing between the vehicle 95 and the MIMO antenna, thus achieving a beam acquisition.

The base station 100 is configured to perform a beam detection operation together with the mobile UE 90 to establish a wireless communication connection

The base Station 100 can instruct the mobile UE 90 to identify and report the best CSI Reference Signal and associated beam, e.g., one of the first to fifth transmission beams 135-1 to 135-5 that are illustrated. This is done using the CSI reporting framework which allows the base station 100 to configure a CSI report with the report Quantity set to cri-RSRP′. This means that the mobile UE 90 generates CSI reports which include a CSI Reference Signal Resource Indicator (CRI) to identify the highest intensity CSI Reference Signal, i.e. the mobile UE 90 identifies and reports the best downlink refined beam. The mobile UE 90 may further report the Layer 1 RSRP which has been measured from the strongest CSI Reference Signal.

The Base Station 100 advantageously instructs the mobile UE 90 to determine and report operating information of the mobile UE 90, including a present geographic position of the mobile UE 90, and a trajectory for the mobile UE 90, which may include speed, heading or direction of travel, acceleration, azimuth of the mobile UE 90 and an elevation of the mobile UE 90 in relation to the MIMO antenna 10 of the base station 100. Such information may be generated by the on-vehicle GPS sensor 91, the navigation system 92, and the plurality of on-vehicle sensors 96 that may include a yaw sensor, a steering angle sensor, wheel speed sensors, etc. that may be employed to determine parameters that include steering angle, vehicle heading, vehicle speed, vehicle acceleration, etc.

Messaging may be reported on a PUSCH (Physical Uplink Shared Channel)/PUCCH (Physical Uplink Control Channel) or any other communication channel. The network may update the matrix in random intervals based on changing network conditions.

The disclosed methods save UE acquisition time, or the time required for the mobile UE 90 to establish a communications link with the base station 100. The disclosed methods further enable high gain during uplink communication, which may be especially useful in autonomous vehicle applications. The disclosed methods enable reasonable or timely use of millimeter wave communications in high mobility application such as use in telematics or cellular devices traveling within a vehicle. The disclosed concepts simplify beam acquisition, thereby saving antenna power.

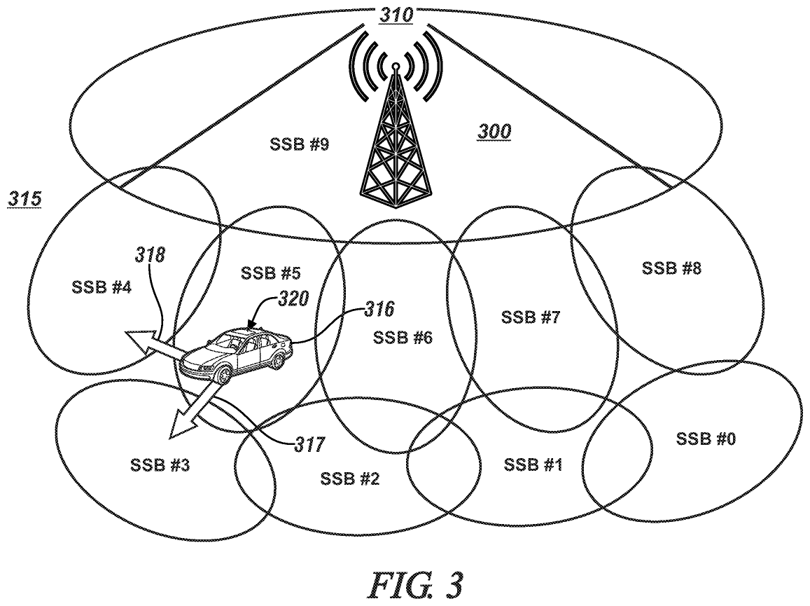

FIG. 3 pictorially illustrates a plurality of synchronization signal block (SSB) regions 320 that are arranged on a ground surface portion 315. The plurality of SSB regions 320 correspond to a plurality of downlink beams that are generated by an embodiment of the MIMO antenna 310 that is part of base station 300 and are transmitted as a burst in the downlink direction. The plurality of SSB regions 320 including SSB region #0, SSB region #1, SSB region #2, SSB region #3, SSB region #4, SSB region #5, SSB region #6, SSB region #7, SSB region #8, and SSB region #9. The ground surface portion 315 represents a coverage area corresponding to the plurality of SSB regions 320 that are transmitted as a burst in the downlink direction, i.e., from the base station 100 to the mobile UE 90.

A vehicle 320 that includes a mobile UE 390 is also shown. Parameters associated with the vehicle 320 include a present geographic location 316, a first trajectory 317, and a second trajectory 318. As shown, the present geographic location 316 of the vehicle 320 is in SSB region #5. The first trajectory 317 leads the vehicle 320 to SSB region #3, and the second trajectory 318 leads the vehicle 320 to SSB region #4.

In accordance with the concepts described herein, when the MIMO antenna 310 generates the downlink beams, it instructs the mobile UE 390 to identify a provisional downlink beam, wherein the provisional downlink beam is one of the first plurality of downlink beams having a highest intensity CSI reference signal at the mobile UE 390. The mobile UE 390 generates a response message that includes the CRI feedback message from the mobile UE 390 that is responsive to the first plurality of downlink beams, wherein the CRI feedback message includes the provisional downlink beam which initially corresponds to SSB region #5. The response message also includes the present geographic location 316 of the vehicle 320 and mobile UE 390, and the trajectory for the mobile UE 390, i.e., one of the first trajectory 317 and the second trajectory 318.

When the vehicle 320 follows the first trajectory 317, the MIMO antenna 310 determines the refined downlink beam based thereon; and transmits the refined downlink beam to SSB region #3 to execute the pairing between the mobile UE 390 and the MIMO antenna 310.

When the vehicle 320 follows the second trajectory 318, the MIMO antenna 310 determines the refined downlink beam based thereon; and transmits the refined downlink beam to SSB region #4 to execute the pairing between the mobile UE 390 and the MIMO antenna 310.

During operation, the present geographic position 316 and the trajectory of the vehicle 320 are updated once per second in one embodiment. During each interim period between updates, the MIMO antenna 310 is able to estimate the location of the vehicle 320, and hence estimate the location of the mobile UE 390 based upon a velocity vector, which may be determined based upon the vehicle heading and the vehicle speed that are elements of the trajectory that is communicated via the mobile UE 390.

The MIMO antenna 310 is able to estimate the location of the vehicle 320, and hence the location of the mobile UE 390 based upon a velocity vector, and update the refined downlink beam to the identified SSB region to execute the pairing between the mobile UE 390 and the MIMO antenna 310, thus maintaining communications.

This facilitates a beam switching decision to the best available beam based upon the latest vehicle information by selecting the provisional downlink beam when it is expected to have a highest intensity CSI reference signal at the mobile UE based upon the present geographic position of the vehicle and the trajectory for the vehicle, and selecting one of the first plurality of downlink beams that is adjacent to the provisional downlink beam when it is expected to have a highest intensity CSI reference signal at the mobile UE based upon the present geographic position of the vehicle and the trajectory for the vehicle.

The concepts provide a system and for smart mobility using enhanced UE feedback mechanism to a cell tower antenna while beamforming in millimeter wave communication. The mobile UE's/vehicle parameters including direction, location and velocity are fed to the network element through the CRI, and the controller will determine the next beam (SSB index) it needs to switch, if required. This facilitates use of millimeter wave in high mobility environments, such as on-vehicle applications, and addresses issues related to data degradation during mobility, while optimizing antenna power usage because the focus is the directive gain of antenna beam to be retained with the UE. The tower would not know which way the vehicle is headed. The controller of the base station has multiple elements within the antenna to determine the best beam to transmit data to the mobile UE based on the CRI feedback including the information that is received from the mobile UE. The CRI feedback may be periodic, non-periodic or semi-persistent. The CSI-RS is reported on PUSCH/PUCCH physical channel. Based on the vehicular parameters, the network element focuses on the best available beam as the serving beam for millimeter wave communication.

While the best modes for carrying out the disclosure have been described in detail, those familiar with the art to which this disclosure relates will recognize various alternative designs and embodiments for practicing the disclosure within the scope of the appended claims.

What is claimed is:

1. A system for wireless pairing to a mobile user equipment (UE), the system comprising:
a base station including a Multiple-Input Multiple-Output (MIMO) antenna operatively connected to a controller;
wherein the MIMO antenna includes a plurality of beamforming antenna elements; and
wherein the controller includes algorithmic code that is executable to:
transmit, via the MIMO antenna, a first plurality of downlink beams, wherein the first plurality of downlink beams includes a plurality of Channel State Information (CSI) reference signals;
instruct the mobile UE to identify a provisional downlink beam, wherein the provisional downlink beam is one the first plurality of downlink beams having a highest intensity CSI reference signal at the mobile UE;
receive, via the MIMO antenna, a CSI reference signal Resource Indicator (CRI) feedback message from the mobile UE responsive to the first plurality of downlink beams, wherein the CRI feedback message includes the provisional downlink beam, a present geographic position of the mobile UE, and a trajectory for the mobile UE;
determine a refined downlink beam based upon the provisional downlink beam, the present geographic position of the mobile UE, and the trajectory for the mobile UE; and
transmit, via the MIMO antenna, the refined downlink beam to execute a pairing between the mobile UE and the MIMO antenna.

2. The system of claim 1, wherein the controller including executable code to determine the refined downlink beam based upon the provisional downlink beam, the present geographic position of the mobile UE, and the trajectory for the mobile UE comprises the controller including executable code to select one of the first plurality of downlink beams that is expected to have the highest intensity CSI reference signal at the mobile UE based upon the present geographic position of the mobile UE and the trajectory for the mobile UE.

3. The system of claim 2, comprising the controller including executable code to select the provisional downlink beam when it is expected to have the highest intensity CSI reference signal at the mobile UE based upon the present geographic position of the mobile UE and the trajectory for the mobile UE.

4. The system of claim 2, comprising the controller including executable code to select one of the first plurality of downlink beams that is adjacent to the provisional downlink beam when it is expected to have the highest intensity CSI reference signal at the mobile UE based upon the present geographic position of the mobile UE and the trajectory for the mobile UE.

5. The system of claim 1, further comprising the controller including executable code to update the refined downlink beam based upon the present geographic position of the mobile UE and the trajectory for the mobile UE.

6. The system of claim 1, wherein the MIMO antenna comprises a Multiple-Input Multiple-Output (MIMO) antenna array.

7. The system of claim 6, wherein the MIMO antenna array includes a 4×4 antenna array.

8. The system of claim 1, wherein the downlink beams comprise static downlink beams.

9. The system of claim 1, further comprising the controller including algorithmic code to communicate between the controller and the mobile UE.

10. The system of claim 1, wherein the controller includes algorithmic code that is executable to transmit, via the MIMO antenna, the refined downlink beam to execute the pairing between the mobile UE and the MIMO antenna to effect millimeter wave communication between the controller and the mobile UE.

11. The system of claim 1, wherein the mobile UE is arranged on a vehicle, and wherein the CRI feedback message includes the provisional downlink beam, a present geographic position of the vehicle, and a trajectory for the vehicle.

12. The system of claim 11, wherein the trajectory for the vehicle includes a present velocity for the vehicle and a direction of travel for the vehicle.

13. A beamforming system for wireless communication to a user equipment (UE) that is arranged on a vehicle, the beamforming system comprising:
a Multiple-Input Multiple-Output (MIMO) beamforming antenna in communication with a controller;
the controller including algorithmic code that is executable to:
transmit a first plurality of downlink beams from the MIMO beamforming antenna, wherein the first plurality of downlink beams includes a plurality of CSI reference signals;
instruct the UE to identify a provisional downlink beam, wherein the provisional downlink beam is one the first plurality of downlink beams having a highest intensity CSI reference signal at the UE;
receive, via the MIMO beamforming antenna, a CSI reference signal Resource Indicator (CRI) feedback message from the UE responsive to the first plurality of downlink beams, wherein the CRI feedback message includes a provisional downlink beam, a present geographic position of the vehicle, and a trajectory for the vehicle;
determine a refined downlink beam based upon the provisional downlink beam, the present geographic position of the vehicle, and the trajectory for the vehicle; and
execute a pairing between the controller and the UE via the refined downlink beam of the MIMO beamforming antenna.

14. The beamforming system of claim 13, further comprising the controller including algorithmic code that is executable to effect millimeter wave communication between the controller and the UE via the refined downlink beam of the MIMO beamforming antenna based on the pairing between the controller and the UE.

15. The beamforming system of claim 13, wherein the controller including executable code to determine the refined downlink beam based upon the provisional downlink beam, the present geographic position of the vehicle, and the trajectory for the vehicle comprises the controller including executable code to select one of the first plurality of downlink beams that is expected to have the highest intensity CSI reference signal at the UE based upon the present geographic position of the vehicle and the trajectory for the vehicle.

16. The beamforming system of claim 15, comprising the controller including executable code to select the provisional downlink beam when it is expected to have the highest intensity CSI reference signal at the UE based upon the present geographic position of the vehicle and the trajectory for the vehicle.

17. The beamforming system of claim 15, comprising the controller including executable code to select one of the first plurality of downlink beams that is adjacent to the provisional downlink beam when it is expected to have the highest intensity CSI reference signal at the UE based upon the present geographic position of the vehicle and the trajectory for the vehicle.

18. The beamforming system of claim 13, wherein the MIMO beamforming antenna includes a 4×4 antenna array.

19. A method for pairing a Multiple-Input Multiple-Output (MIMO) antenna to a mobile user equipment (UE), the method comprising:
transmitting, via the MIMO antenna, a first plurality of downlink beams, wherein the first plurality of downlink beams includes a plurality of Channel State Information (CSI) reference signals;
instructing the mobile UE to identify a provisional downlink beam, wherein the provisional downlink beam is one the first plurality of downlink beams having a highest intensity CSI reference signal at the mobile UE;
receiving, via the MIMO antenna, a CSI reference signal Resource Indicator (CRI) feedback message from the mobile UE responsive to the first plurality of downlink beams, wherein the CRI feedback message includes the provisional downlink beam, a present geographic position of the mobile UE, and a trajectory for the mobile UE;
determining a refined downlink beam based upon the provisional downlink beam, the present geographic position of the mobile UE, and the trajectory for the mobile UE; and
transmitting, via the MIMO antenna, the refined downlink beam to execute a pairing between the mobile UE and the MIMO antenna.

20. The method of claim 19, comprising
selecting the provisional downlink beam when it is expected to have the highest intensity CSI reference signal at the UE based upon the present geographic position of the vehicle and the trajectory for the vehicle; and
selecting one of the first plurality of downlink beams that is adjacent to the provisional downlink beam when it is expected to have the highest intensity CSI reference signal at the UE based upon the present geographic position of the vehicle and the trajectory for the vehicle.
